(19) United States
(12) Patent Application Publication
(10) Pub. No.: US 2025/0196817 A1
(43) Pub. Date: Jun. 19, 2025

(54) Vehicle Tire Inflation System and Method of Use Thereof

(71) Applicant: Diane Davis, Milwaukee, WI (US)

(72) Inventor: Diane Davis, Milwaukee, WI (US)

(21) Appl. No.: 18/645,863

(22) Filed: Apr. 25, 2024

Related U.S. Application Data
(60) Provisional application No. 63/609,495, filed on Dec. 13, 2023.

(51) Int. Cl. B60S 5/04

(52) U.S. Cl. CPC B60S 5/04

(57) ABSTRACT

A vehicular tire air pump system designed for public use at gas stations and along highways is disclosed. The system features a durable, weather-resistant body anchored to the ground, and is equipped with a pump compressor for generating and autonomously regulating compressed air based on user-defined pressure thresholds displayed on a digital touch screen. The air hose of the system includes a non-flexible (i.e., rigid) and elongated portion that can be held by a user in a standing position and has a threaded female adaptor for secure, ergonomic connection to tire valves, enabling inflation from a standing position. The system integrates a multifunctional LED for status indication, a payment module accepting coins, cash, and cards, and a speaker for multilingual operational voice alerts. In some embodiments, the system has an NFC camera for tire health assessment and automatic car model recognition and a location tracker.

### CROSS-REFERENCE TO RELATED APPLICATION

The present application claims priority to, and the benefit of, U.S. Provisional Application No. 63/609,495, which was filed on Dec. 13, 2023 and is incorporated herein by reference in its entirety.

### FIELD OF THE INVENTION

The present invention generally relates to the field of tire inflation devices. More specifically, the present invention relates to a novel air pump compressor system designed to fill vehicle tires with air without requiring a user to bend and kneel. The system has an air hose operatively connected to an air pump and the air hose has a non-flexible and elongated portion. The elongated portion can be used by a user in a standing position to inflate air. A female adaptor designed to couple to a male tire valve is disposed at one end of the elongated portion for inflating tires. The system has a display for displaying tire pressure PSI threshold wherein the system automatically (i.e., autonomously) pumps air until the predefined tire pressure threshold is reached, at which point the pump deactivates to prevent overinflation. Accordingly, the present disclosure makes specific reference thereto. Nonetheless, it is to be appreciated that aspects of the present invention are also equally applicable to other like applications, devices, and methods of manufacture.

### BACKGROUND

By way of background, maintaining proper tire inflation is important for vehicle maintenance and directly impacts safety, fuel efficiency, and the overall lifespan of the tires. Vehicle tires naturally lose air over time due to a variety of factors, including permeation through the tire walls, minor punctures, or changes in temperature. This gradual deflation can lead to under-inflated tires, significantly increasing the risk of tire failure, such as flats or blowouts, which can be dangerous especially when driving at high speeds on highways.

Traditionally, drivers replenish their vehicle's tire air at gas stations, where air pump stations are commonly found. Conventional air pumps require a user to bend over or kneel close to the ground to attach the air hose to the tire's valve. For individuals who have to inflate all four tires during a single stop, the bending and kneeling position is extremely discomforting and painful. Use of conventional pump stations is particularly uncomfortable, difficult, or even painful for individuals with limited physical strength, dexterity, mobility issues, or existing injuries. Bending over or kneeling can strain the back, knees, and joints, which not only causes immediate discomfort but may also exacerbate or lead to chronic pain issues.

Moreover, the requirement of tire inflation can arise during long highway journeys and gas stations or specifically, air pumps may not be readily available on long highways. Drivers may not often carry portable air inflation devices due to a lack of awareness, perceived need, or space constraints within the vehicle. There is a need for a more accessible, user-friendly air pump system that can be used comfortably by a wider range of individuals, including those with physical limitations or those who simply wish to avoid the discomfort associated with traditional air pumps.

Therefore, there exists a long felt need in the art for a vehicle tire inflating device that eliminates the need for users to bend over or kneel for inflating tires. There is also a long felt need in the art for an improved air pump system that provides a standing-operable mechanism with a hose that easily reaches and attaches to the tire valve. Additionally, there is a long felt need in the art for a vehicle tire inflation system that can be used at gas stations, highways, and at other locations. There is also a long felt need in the art for a vehicle tire inflating device that fills tires to a selected tire pressure and automatically (i.e., autonomously) deactivates once the threshold is reached. Further, there is a long felt need in the art for a vehicle tire inflating device that enables an individual to easily inflate tires in an authorized manner. Finally, there is a long felt need in the art for a multipurpose tire inflation machine that makes tire inflation a quick, effortless, and pain-free task for all drivers.

The subject matter disclosed and claimed herein, in one embodiment thereof, comprises an air pump machine for inflating vehicle tires. The machine includes an air pump for producing pressurized air, an air hose is operatively connected to the air pump and includes a flexible portion and an elongated and non-flexible member. One end of the elongated and rigid member includes a female adaptor for coupling with a male tire valve to inflate the tire using the pressurized air. The elongated and rigid member can be held by an individual from the top end thereof, thereby eliminating the requirement of bending and kneeling by the individual for inflating tires. The machine also includes a digital display configured to show and adjust air pressure thresholds preconfigured by the user.

In this manner, the vehicle tires inflation device of the present invention accomplishes all of the forgoing objectives and provides users with an air pump machine designed to put air into tires without having to bend over and risk aches, pains, and injuries. The device enables users to operate the machine from a comfortable standing position. The device eliminates the need to bend over or kneel, possibly through a standing-operable mechanism with a hose that easily reaches and attaches to the tire valve. The device can be installed at highway locations to enhance convenience by ensuring drivers have access to tire inflation facilities even when traveling far from conventional service stations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicular tire air pump machine. The machine further comprises a pump system body having a base and a top end, the top end is bolted to a ground surface. A pump compressor is housed within the body for generating compressed air and an air hose is operatively connected to the pump compressor. A digital display is disposed on the front surface of the top end of the body and is configured to show and adjust preconfigured tire pressure thresholds. The air hose has a threaded female adaptor at a free end of an elongated and rigid member of the air hose for securely attaching to a male tire valve, facilitating inflation from a standing position.

In another aspect, an air pump machine for inflating vehicle tires is disclosed. The machine includes an air pump for producing pressurized air, an air hose is operatively connected to the air pump and includes a flexible portion and an elongated and non-flexible member. One end of the elongated and rigid member includes a female adaptor for coupling with a male tire valve to inflate the tire using the pressurized air. The elongated and rigid member can be held by an individual from the top end thereof, thereby eliminating the requirement of bending and kneeling by the individual for inflating tires. The machine also includes a digital display configured to show and adjust air pressure thresholds preconfigured by the user, an LED illumination source for indicating operational status in multiple colors, and a speaker configured to play voice messages in various languages, indicating the operational status of the machine.

In another embodiment, the machine includes a location tracker for location tracking of a Near Field Communication (NFC) camera for assessing tire health of a vehicle and automatically (i.e., autonomously) identifying car models for specific tire pressure requirements. NFC is a wireless connectivity technology that enables fast short-range communication between electronic devices like phones and cameras.

In another aspect, the machine/system includes a payment module equipped with a coin inlet, a card reader, and a receipt slot for versatile payment options and secure transactions; a digital display with touch capability for easy preconfiguration of tire pressure, and an NFC camera system for providing tire health diagnostics and car model identification, offering a comprehensive, user-friendly interface and enhanced service delivery to vehicle owners.

In yet another embodiment, a method for inflating vehicle tires using a vehicular tire air pump machine is described. The method comprises providing the air pump machine, the machine includes an air pump, a touch display, an air hose operatively connected to the air pump, the air hose includes a non-flexible and elongated portion having a female adaptor for connection to a male tire valve. The method also includes predefining a tire pressure threshold value using the touch display, receiving a payment through a payment module, and generating a receipt, coupling the female adaptor to a male tire valve, and automatically (i.e., autonomously) pumping air until the predefined tire pressure threshold is reached, at which point the pump deactivates to prevent overinflation.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the vehicular tire air pump machine of the present invention in accordance with the disclosed architecture;

FIG. 2 illustrates a perspective view of the vehicular tire air pump system of the present invention showing the compressor air pump and the cash receiving container in accordance with the disclosed structure;

FIG. 3 illustrates a rear perspective view of the vehicle tire air pump system of the present invention in accordance with the disclosed structure;

FIG. 4 illustrates a perspective view showing a user using the vehicle tire inflation system of the present invention for easily filling air in the vehicle tires in accordance with the disclosed structure;

FIG. 5 illustrates a flow chart depicting a process of use of the vehicle tire air filling system of the present invention for filling air in vehicle tires in accordance with one embodiment of the disclosed structure;

FIG. 6 illustrates another interface displayed by the digital display of the system in accordance with one embodiment of the present invention; and

FIG. 7 illustrates another embodiment of the vehicle tires inflation system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a vehicle tire inflating device that eliminates the need for users to bend over or kneel for inflating tires. There is also a long felt need in the art for an improved air pump system that provides a standing-operable mechanism with a hose that easily reaches and attaches to the tire valve. Additionally, there is a long felt need in the art for a vehicle tire inflation system that can be used at gas stations, highways, and at other locations. There is also a long felt need in the art for a vehicle tire inflating device that fills tires to a selected tire pressure and automatically (i.e., autonomously) deactivates once the threshold is reached. Further, there is a long felt need in the art for a vehicle tire inflating device that enables an individual to easily inflate tires in an authorized manner. Finally, there is a long felt need in the art for a multipurpose tire inflation machine that makes tire inflation a quick, effortless, and pain-free task for all drivers.

The present invention, in one exemplary embodiment, is a vehicular tire air pump machine. The machine further comprises a pump system body having a base and a top end, the top end is bolted to a ground surface. A pump compressor is housed within the body for generating compressed air and an air hose is operatively connected to the pump compressor. A digital display is disposed on the front surface of the top end of the body and is configured to show and adjust preconfigured tire pressure thresholds. The air hose has a threaded female adaptor at a free end of an elongated and rigid member of the air hose for securely attaching to a male tire valve, thereby facilitating inflation from a standing position.

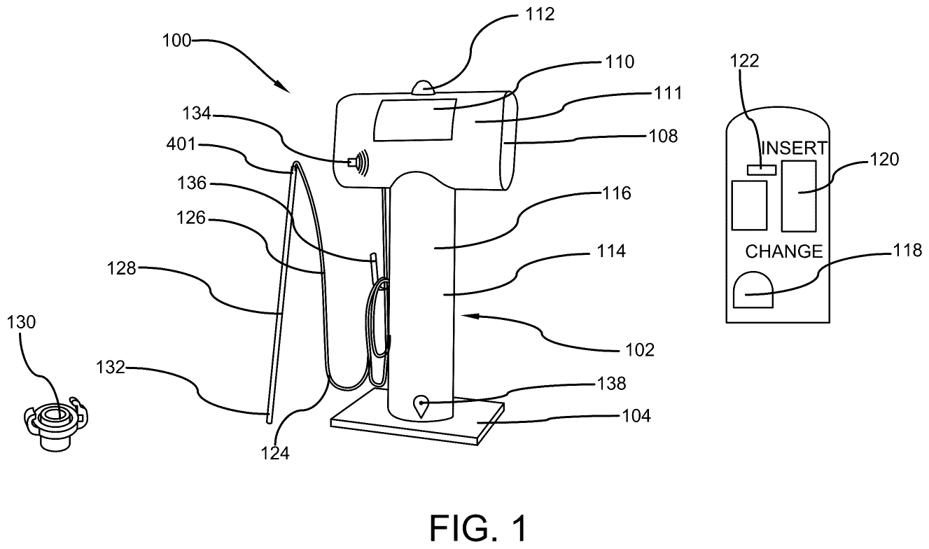

Referring initially to the drawings, FIG. 1 illustrates a perspective view of the vehicular tire air pump machine of the present invention in accordance with the disclosed architecture. The vehicular tire air pump machine 100 of the present invention is designed as a standalone air pump compressor system to fill vehicle tires with air at gas stations. The vehicular tire air pump system 100 can be installed at gas stations and alongside the highways for users to easily fill air in vehicle tires without any professional help. Unlike conventional air pumps that require the user to hold the hose in place, the system 100 includes a threaded female adaptor that securely screws onto the male tire valve. The vehicular tire air pump system 100 prevents older users or those with back pain (i.e., individuals with limited mobility) from having to bend over and hold the hose onto a male tire valve.

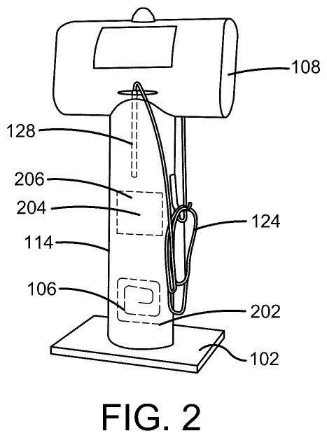

More specifically, the vehicular tire air pump system 100 includes a pump system body 102 which is installed on the ground using a base 104. The base 104 can be bolted permanently to the ground, or selectively detachable from the ground, as per user preferences and can require an authorization to remove the air pump system 100 from the ground. The body 102 includes a pump compressor 106 (illustrated in FIG. 2) therein for generating compressed air for pumping vehicle tires. The body 102 includes a top end 108 that has a digital display 110 disposed on the front surface 111 thereof. The digital display 110 is adapted to display an air pressure preconfigured by a user and the pump compressor 106 pumps the air according to the displayed air pressure on the digital display 110. The preconfigured air pressure functions as an air pressure threshold and the pump compressor 106 automatically (i.e., autonomously) deactivates pumping air when the air pressure threshold is reached. The digital display 110 can be a touch display which enables a user to preconfigure an air pressure for a vehicle tire.

An illumination source 112, preferably in the form of an LED is disposed on the top end 108 for indicating the working status of the air pump system 100. In one exemplary embodiment, the LED 112 illuminates in a first color such as Red when the system 100 is used for pumping air into a vehicle tire. The LED 112 illuminates in a second color such as Green when the system 100 is not in use. The LED 112 can illuminate in a third color such as Yellow when the system 100 is malfunctioned and not working properly. The LED 112 also helps users locate the system 100 at night when installed along a highway.

A longitudinal member 114 of the body 102 has a payment module 116 disposed thereon for enabling users to pay for using the air pump system 100. The payment module 116 enables a user to pay using coins/cash via a cash and coin inlet(s) 118 and credit/debit cards using a card reader 120. A receipt slot 122 provides a receipt for the payment and use of the air pump system 100.

The vehicle tire air pump machine 100 includes an air hose 124 extending from the body 102 for inflating a vehicle tire. The air hose 124 includes a flexible hose length 126 which can be folded and looped for easy storage. The air hose 124 also includes a longitudinal and elongated and rigid member 128 that does not bend and has a female connector 130 at the free end 132 thereof. The female connector 130 is configured to easily attach to a male tire valve for inflating the tire using the system 100 wherein a user can stand and hold the member 128 without bending to inflate the tire.

The body 102 includes a speaker 134 configured for playing out a voice message indicating operational status of the system 100. For example, the speaker 134 can playout the audio message, “Air has been filled at 35 PSI” when a tire inflation process is complete. The speaker 134 is adapted to playout messages in different languages to accommodate different user needs. The longitudinal member 114 has an arcuate shaped hook 136 disposed thereon for accommodating the flexible hose length 126 for easy storage and safety of the air hose 124. The system 100 can also have a location tracker 138 which can be in the form of a GPS tracker for tracking location of the system 100.

The body 102 is preferably made of a lightweight, durable, corrosion-resistant, and weatherproof material. Further, the system 100 can be installed at any convenient location for enabling users to easily pump air in their vehicle tires.

FIG. 2 illustrates a perspective view of the vehicular tire air pump system 100 of the present invention showing the compressor air pump and the cash receiving container in accordance with the disclosed structure. As illustrated, the longitudinal member 114 of the body 102 is hollow inside and includes the pump 106 which is operatively connected to the air hose 124. The pump 106 generates pressurized air for inflating tires of a vehicle and regulates the pressure according to a preconfigured tire-PSI pressure stored in a pressure module 202.

A cash collecting box 204 is disposed inside the longitudinal member 114 for collection of the cash received through the payment module 116. A receipt module 206 includes a printing paper roll (not shown) thereon which is automatically (i.e., autonomously) printed for providing receipt through the receipt slot 122. It will be apparent to a person skilled in the art that the payment module 116 is secured and cannot be removed or tempered by any unauthorized individual.

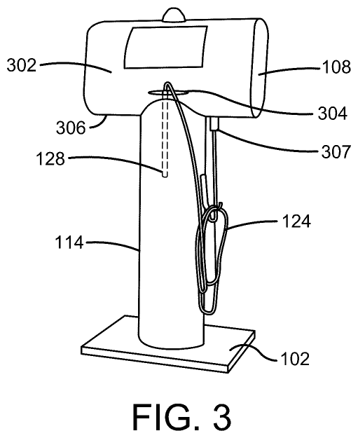

FIG. 3 illustrates a rear perspective view of the vehicle tire air pump system 100 of the present invention in accordance with the disclosed structure. The rear surface 302 of the top end 108 of the body 102 has a loop 304 disposed thereon for holding the elongated and rigid member 128 of the air hose 124. The loop 304 prevents the elongated and rigid member 128 from physical damage. The air hose 124 extends out from point 307 of the bottom surface 306 of the top end 108 and carries the pressurized air from the pump 106. The elongated and rigid member 128 enables an individual to operate the system 100 from a comfortable standing position instead of being bent over on the hands and knees as required in conventional vehicle tire inflation devices.

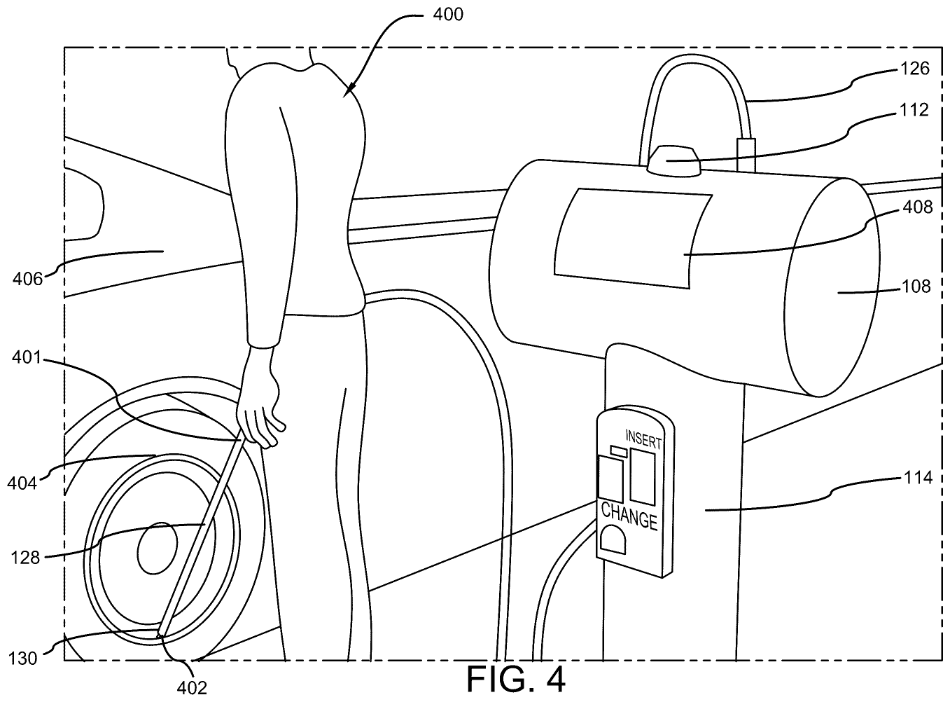

FIG. 4 illustrates a perspective view showing a user using the vehicle tire inflation system of the present invention for easily filling air in the vehicle tires in accordance with the disclosed structure. As illustrated, a user 400 can hold the elongated and rigid member 128 from the top end 401 to easily couple the female connector 130 at the free end 132 of the elongated and rigid member 128 to the valve 402 of a tire 404 of a vehicle 406. The female connector 130 can also be easily removed after filling air based on the preconfigured PSI value 408, thereby eliminating bending of the user 400.

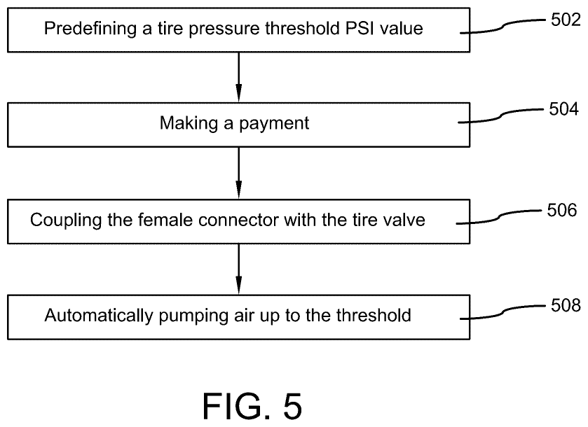

FIG. 5 illustrates a flow chart depicting a process of use of the vehicle tire air filling system of the present invention for filling air in vehicle tires in accordance with one embodiment of the disclosed structure. Initially, a user predefines a tire pressure threshold PSI value using the touch display or a keyboard disposed on the system (Step 502). The system 100 can be configured to provide air pressure for all types of vehicles. Then, the user makes a payment using the payment module 116 and receives a receipt of the payment (Step 504). Thereafter, the user removes the elongated and rigid member 128 from the loop 304 and couples the female connector 130 with the tire valve (Step 506). The pump of the system 100 automatically (i.e., autonomously) pumps the pressurized air up to the predefined tire pressure threshold PSI value and on reaching the threshold, the pump automatically (i.e., autonomously) stops the pressurized air (Step 508), thereby preventing the tire from bursting and eliminating manual checking of air pressure by a user.

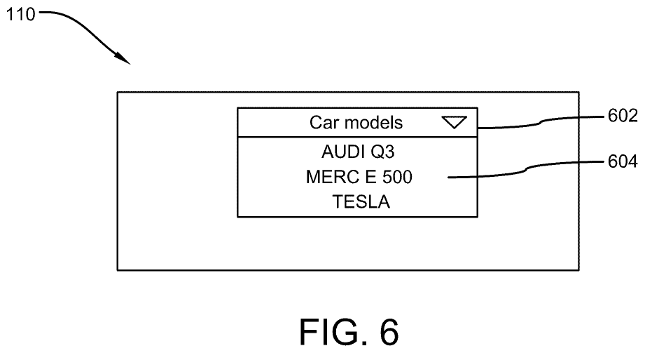

FIG. 6 illustrates another interface displayed by the digital display 110 of the system in accordance with one embodiment of the present invention. In the present embodiment, the digital display 110 displays a drop down menu 602 including a list of car models 604. A user can select a car model and based on location of the air pump system 100, an automatic tire air pressure threshold is detected and displayed by the system 100. The location is considered in the present embodiment as different tire pressure may be required on highways and on local roads. Based on the location of the system 100, different thresholds can be displayed by the system 100 for the same car model.

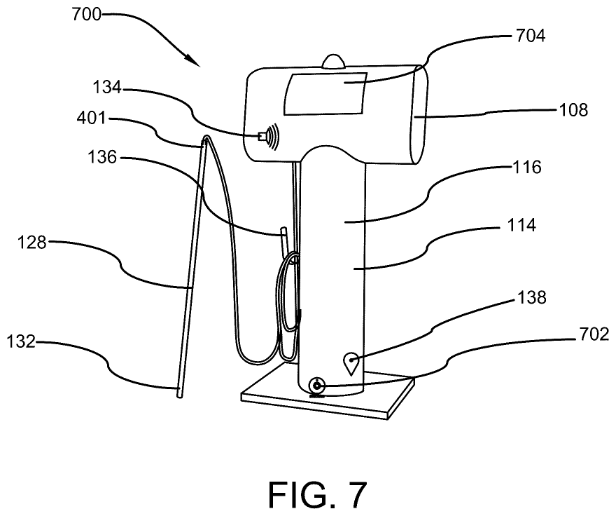

FIG. 7 illustrates another embodiment of the vehicle tires inflation system of the present invention in accordance with the disclosed structure. In the present embodiment, the system 700 includes all the features and components of the system 100 of FIG. 1 and further includes an NFC camera 702 for assessing health of the tires of a vehicle standing near the system 700 for inflating tires. The NFC camera 702 is automatically (i.e., autonomously) activated upon successful payment by a user. The system 700 can display the tire's health, such as tread depth and potential punctures on the display 704 of the system 700. The NFC camera 702 can also identify a car model to indicate specific tire pressure requirements of the tires of the vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicular tire air pump machine”, “vehicle tire air pump system”, “air pump system”, and “system” are interchangeable and refer to the vehicle tire air pump system 100, 700 of the present invention.

Notwithstanding the forgoing, the vehicle tire air pump system 100, 700 of the present invention can be of any suitable size and configuration as is known in the art without affecting the overall concept of the invention, provided that it accomplishes the above stated objectives. One of ordinary skill in the art will appreciate that the vehicle tire air pump system 100, 700 as shown in the FIGS. are for illustrative purposes only, and that many other sizes and shapes of the vehicle tire air pump system 100, 700 are well within the scope of the present disclosure. Although the dimensions of the vehicle tire air pump system 100, 700 are important design parameters for user convenience, the vehicle tire air pump system 100, 700 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicular tire air pump machine comprising:
an air pump compressor;
a pump body;
a base;
an air hose;
a rigid elongated member; and
a female connector;
wherein said air hose connected to said rigid elongated member;
wherein said rigid elongated member having said female connector at a free end;
wherein said female connector attachable to a male tire valve for inflating a tire; and
further wherein said rigid elongated member reachable to said male tire valve with a user in a standing position.

2. The vehicular tire air pump machine of claim 1, wherein said base permanently attached to the ground.

3. The vehicular tire air pump machine of claim 1, wherein said base selectively detachable from the ground.

4. The vehicular tire air pump machine of claim 3, wherein said air pump compressor generating compressed air for pumping vehicle tires.

5. The vehicular tire air pump machine of claim 4, wherein said pump body having a top end including a digital display disposed on a front surface of said pump body.

6. The vehicular tire air pump machine of claim 5, wherein said digital display is a display of an air pressure preconfigured by a user.

7. The vehicular tire air pump machine of claim 6, wherein said air pump compressor pumps the air according to the display of said air pressure on said digital display.

8. The vehicular tire air pump machine of claim 7, wherein said air pressure is an air pressure threshold; and further wherein said air pump compressor autonomously deactivates said air pump compressor when said air pressure equals said air pressure threshold.

9. The vehicular tire air pump machine of claim 8, wherein said female connector is a threaded female adaptor.

10. The vehicular tire air pump machine of claim 9, wherein said digital display is a touch display.

11. A vehicular tire air pump machine comprising:
an air pump compressor;
a pump body;
a base;
an air hose;
a rigid elongated member;
a female connector; and
a speaker;
wherein said air hose connected to said rigid elongated member;
wherein said rigid elongated member having said female connector at a free end;
wherein said female connector attachable to a male tire valve for inflating a tire;
wherein said rigid elongated member reachable to said male tire valve with a user in a standing position;
wherein said pump body having a top end including a digital display disposed on a front surface of said pump body;
wherein said digital display is a display of an air pressure preconfigured by a user;
wherein said air pump compressor pumps the air according to the display of said air pressure on said digital display; and
further wherein said speaker includes an audible alert of said air pressure.

12. The vehicular tire air pump machine of claim 11, wherein said air pressure is an air pressure threshold, further wherein said air pump compressor autonomously deactivates said air pump compressor when said air pressure equals said air pressure threshold.

13. The vehicular tire air pump machine of claim 12, wherein said base permanently attached to the ground.

14. The vehicular tire air pump machine of claim 12, wherein said base selectively detachable from the ground.

15. The vehicular tire air pump machine of claim 13, wherein said air pump compressor generating compressed air for pumping vehicle tires.

16. The vehicular tire air pump machine of claim 15, wherein said female connector is a threaded female adaptor.

17. The vehicular tire air pump machine of claim 16, wherein said digital display is a touch display.

18. A vehicular tire air pump machine comprising:
an air pump compressor;
a pump body;
a base;
an air hose;
a rigid elongated member;
a female connector;
a speaker; and
a location tracker;
wherein said air hose connected to said rigid elongated member;
wherein said rigid elongated member having said female connector at a free end;
wherein said female connector attachable to a male tire valve for inflating a tire;
wherein said rigid elongated member reachable to said male tire valve with a user in a standing position;
wherein said pump body having a top end including a digital display disposed on a front surface of said pump body;
wherein said digital display is a display of an air pressure preconfigured by a user;
wherein said air pump compressor pumps the air according to the display of said air pressure on said digital display;
wherein said speaker includes an audible alert of said air pressure; and
further wherein said location tracker includes a GPS tracker attached to said pump body for locating each of the vehicular tire air pump machines.

19. The vehicular tire air pump machine of claim 18, wherein said air pressure is an air pressure threshold, further wherein said air pump compressor autonomously deactivates said air pump compressor when said air pressure equals said air pressure threshold.

20. The vehicular tire air pump machine of claim 18 further comprising an NFC camera, wherein at least one tire of the vehicle is viewable to said NFC camera for assessing a health status of said at least one tire of the vehicle proximal to the vehicular tire air pump machine.
